(19) United States
(12) Patent Application Publication
(10) Pub. No.: US 2026/0059074 A1
(43) Pub. Date: Feb. 26, 2026

(54) COMPUTER-IMPLEMENTED METHODS AND SYSTEMS FOR VIRTUAL LEGAL PROCEEDINGS

(71) Applicant: Matthew P. Hars, New York, NY (US)

(72) Inventor: Matthew P. Hars, New York, NY (US)

(21) Appl. No.: 18/810,781

(22) Filed: Aug. 21, 2024

(51) Int. Cl. H04N 7/15; G06Q 50/18; G06T 13/40

(52) U.S. Cl. CPC H04N 7/157; G06Q 50/18; G06T 13/40

(57) ABSTRACT

According to an aspect of the present invention, there is provided a system for providing a virtual courtroom which includes displaying, on the display associated with the computer terminal, a realistic simulations of a physical courtroom including visual cues pertinent to a traditional court setting; storing in the computer memory device parameters for AI-generated avatars representing judges, attorneys, witnesses, and/or jurors, each equipped with distinct appearances, personalities, knowledge bases, and behavioral tendencies; and displaying, on the display associated with the computer terminal, the reaction of the AI-generated avatars representing judges, attorneys, witnesses, and/or jurors.

### PRIORITY CLAIM

This application claims priority to US Provisional Patent Application Number 63/533,769, filed Aug. 21, 2023, and incorporated herein by reference.

### BACKGROUND

Computer-implemented systems and methods for legal professionals, such as ones providing information in response to a computerized search for legal content, are well-known in the patent literature.

For example, US20150032645 provides techniques for the automation of legal document review and creation of summary documents. The disclosed subject matter can be operated in training mode or classification mode. A preprocessor generates candidate items and associated features from input documents. Candidate items can be presented to a machine learning classifier, which classifies them as relevant or not relevant to a given legal category. A summary document can be provided including the relevant candidates.

US20200151392 describes a system for automated analysis of legal documents within and across different fields which is constructed using a computer system comprising at least one memory, at least one processor, and at least a first plurality of programming instructions stored in the at least one memory and operating on the at least one processor configured to allow the operation on the computer system of additional programming instructions, an extraction processor to identify, extract knowledge from data contained in the legal document and transform it into a common data form. The analysis processor develop a local and global knowledge graphs containing the key entities, relationships and concepts encoded in the text.

U.S. Pat. No. 6,067,531 discloses a contract system which automates negotiation and generation of contract documents by managing the work flow in a contract approval process. Multiple users, coupled by a computer network, access a contract database containing multiple contracts with multiple contract components therein. The system manages communications and security between a client system and the contract database. A client applet facilitates user input at the client system and assists in a standardization of legal phrasing and contract negotiation. The client applet enforces business rules to qualify a contract for expedited approval. Generalized templates are employed to enable rapid prototyping and creation of new contracts. A method governs the automated contract negotiation and generation process within a business organization with assistance from a graphical user interface.

US20210109958 discloses a trained model which could represent a court's opinion about how laws are applied to different situations. This trained model can receive the user's query as a summary of facts or a sequence of keywords, and it produces the relevant laws through the lens of the court. This model may not need to go through the entire database, nor does it need to perform an extensive search to find relevant cases containing the query entered by the user. Rather, the trained model of the research system looks at the user's query and directly returns the relevant laws based on the factual patterns in the query and what the model has learned in the training processes used to train it. This compares to conventional research tools, where for each query the research system usually performs a search across the database to find case files that contain the user's query.

Nonetheless, additional innovation in computer-implemented methods and systems for legal professionals and others involved with the legal system is desirable.

### SUMMARY OF INVENTION

Accordingly, embodiments of the present invention provide an artificial intelligence-based legal system and associated methods adaptable for both real world and metaverse applications. The AI system comprises augmented reality and virtual reality subsystems to create immersive legal environments. The system includes AI entities like virtual attorneys, judges, jurors capable of simulating human roles and behaviors.

According to an aspect of the present invention, there is provided a system for providing a virtual courtroom, comprising: a computer terminal; at least one input/output device(s) associated with and communicatively connected to the computer terminal; a speaker associated with and communicatively connected to the computer terminal; a computer memory device; at least one display associated with the computer terminal; and at least one processor arranged for: displaying, on the display associated with the computer terminal, a realistic simulations of a physical courtroom, including visual cues pertinent to a traditional court setting; storing in the computer memory device parameters for AI-generated avatars representing judges, attorneys, witnesses, and/or jurors, each equipped with distinct appearances, personalities, knowledge bases, and behavioral tendencies; displaying, on the display associated with the computer terminal, the AI-generated avatars representing judges, attorneys, witnesses, and/or jurors; receiving, from the at least one input/output device(s) associated with and communicatively connected to a user computer terminal, one or more inputs corresponding to one or more of presenting evidence, examining witnesses, making objections, and deliver closing and/or opening arguments; calculating, by the processor, a reaction to the one or more inputs corresponding to one or more of presenting evidence, examining witnesses, making objections, and deliver closing and/or opening arguments according to the parameters associated with the personalities, knowledge bases, and behavioral tendencies of the AI-generated avatars stored in the computer memory; displaying, on the display associated with the computer terminal, the reaction of the AI-generated avatars representing judges, attorneys, witnesses, and/or jurors; and outputting a sound, from the speaker associated with the computer terminal, indicating the reaction of the AI-generated avatars representing judges, attorneys, witnesses, and/or jurors.

According to another aspect of the present invention, there is provided a virtual legal avatar creator within the virtual courtroom system of claim 1, configured to: allow users to craft realistic digital representations of themselves for virtual court appearances; and feature a range of customization options, from attire to gestures, ensuring a genuine and authentic virtual presence.

### BRIEF DESCRIPTION OF THE DRAWINGS

FIG. 1 illustrates the virtual courtroom environment in an embodiment of the present invention.

FIG. 2 illustrates an algorithm according to an embodiment for providing a virtual courtroom environment.

FIG. 3 is a diagram of a technological environment according to an aspect of the present invention.

### DETAILED DESCRIPTION

The advent of artificial intelligence and increased computing capabilities has opened new possibilities for automating and enhancing legal services. However, existing AI legal solutions tend to be limited in scope and jurisdiction. Further, the emergence of virtual metaverse environments creates new legal complexities involving virtual transactions and disputes.

Some conventional systems such as ROSS Intelligence and Casetext CARA focus solely on legal research and analysis for lawyers. Others like Neota Logic offer more expanded document automation and advising capabilities but lack comprehensive services. Rules-based expert systems using Bayesian networks, decision trees, or ontologies have proven too rigid and simplistic to handle complex legal reasoning.

With exponential growth of data, machine learning techniques show promise for predictive analytics. But these methods alone cannot replicate multifaceted human judgement critical for legal services. End-to-end AI systems combining machine learning with rules-based reasoning, natural language processing, data mining, and other techniques have not been explored adequately thus far.

Further, existing tools lack versatility to operate seamlessly across real world and metaverse environments. There is also a need for transparent AI systems that can explain rationale behind decisions and actions taken to build user trust. Embodiments of the present disclosure aim to address these limitations in conventional legal AI technologies.

The interactive system allows access via gestures, speech and multi-modal inputs. Real-time translation and sentiment analysis facilitate communications across language barriers. The system ensures legal parity between real world and metaverse ecosystems. Holographic projection and shadow counsel capabilities enhance legal consultations and arguments.

Hence the present disclosure provides a versatile, AI-driven legal architecture unifying real world and virtual environments while maintaining transparency and Trust through human-centric design. The present disclosure provides an artificial intelligence-driven legal system and associated methods that unify real world and metaverse environments under a common legal framework.

As used with respect to the present invention, “sending” means transmitting by wired or wireless electronic means in digital format.

As used with respect to the present invention, “AI-enabled” means having been processed according to machine learning algorithms including but not limited to neural networks.

As used with respect to the present invention, “establishing” means completing a computer-implemented process for creation of an electronic transmission channel by a processor.

As used with respect to the present invention, “creator mimics” means simulation of actual human characteristics by a digital imitation.

As used with respect to the present invention, “facial” means pertaining to a human face.

As used with respect to the present invention, “detection” means a computer-implemented process of identification.

As used with respect to the present invention, “familiarize” means a computer-implemented process of repetition.

As used with respect to the present invention, “creator” means the simulator of actual human characteristics by a digital imitation.

As used with respect to the present invention, “characteristics” means human features representable digitally.

As used with respect to the present invention, “representations” means digital simulacra of physical objects.

As used with respect to the present invention, “microphone” means a device for capturing sound.

As used with respect to the present invention, “camera” means an optical device for capturing images.

As used with respect to the present invention, “transmission” means transmitting by wired or wireless electronic means in digital format.

As used with respect to the present invention, “assessing” means processing by a computer processor.

As used with respect to the present invention, “content” means audio, video, or text.

As used with respect to the present invention, “constituting” means created in a particular fashion.

As used with respect to the present invention, “acoustics” means the characteristics of a space with respect to sound.

As used with respect to the present invention, “auditory” means pertaining to sound.

As used with respect to the present invention, “verdict” means a decision in a legal matter.

As used with respect to the present invention, “customizable” means alterable by a user.

As used with respect to the present invention, “ambient” means surrounding.

As used with respect to the present invention, “adjust lighting” means digitally darkening or brightening particular areas.

As used with respect to the present invention, “environmental” means ambient.

As used with respect to the present invention, “demographics” means sex, race, income and similar characteristics and “demographic mix” means the demographics of a pool of persons.

As used with respect to the present invention, “selection” means a computer-implemented process of instantiating a particular digital representation.

As used with respect to the present invention, “highlighting strengths” means digitally describing a particular quality.

As used with respect to the present invention, “adjust tone” means altering a voice sound.

As used with respect to the present invention, “pitch” means the frequency of a sound.

As used with respect to the present invention, “rate” means the speed of a sound.

As used with respect to the present invention, “mechanism” means a particular digital routine.

As used with respect to the present invention, “detect inconsistencies” means comparing by a processor two or more instances of the same category.

As used with respect to the present invention, “tampering” means altering.

As used with respect to the present invention, “fabrications” means alterations.

As used with respect to the present invention, “electronic” means computer-implemented.

As used with respect to the present invention, “stenography” means the action or process of writing in shorthand or taking dictation.

As used with respect to the present invention, “synchronized” means at the same time.

As used with respect to the present invention, “tribunal” means a legal body.

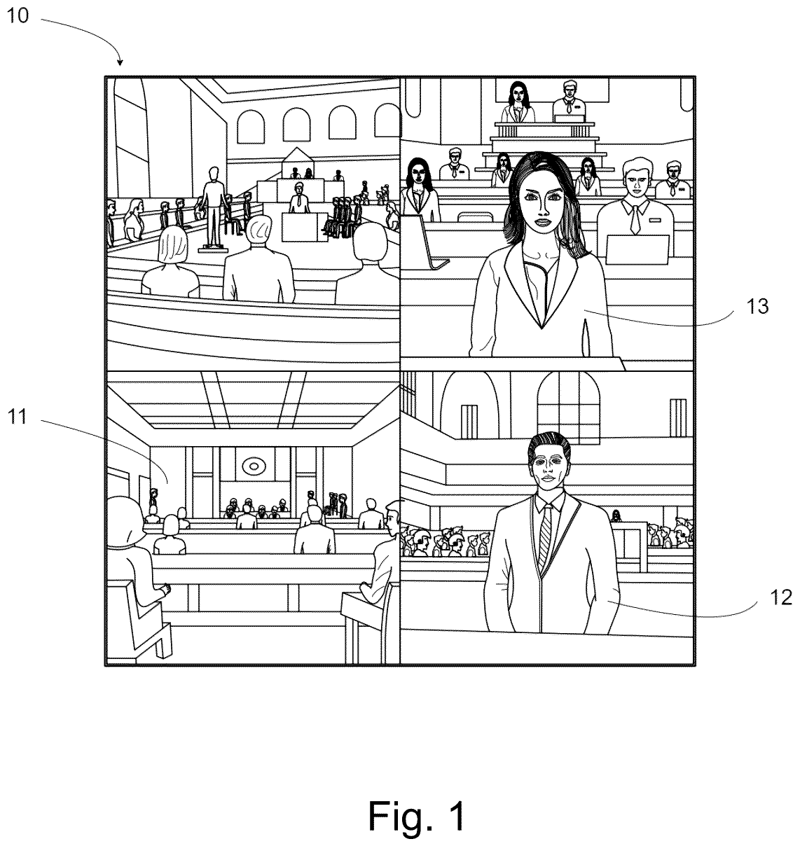

FIG. 1 illustrates the virtual courtroom environment in an embodiment of the present invention.

Interface 10 is a virtual courtroom environment in an application running on a computer system. Populating the immersive environment are a cast of AI-driven entities including virtual attorneys, judges, jurors, clerks and other court officials endowed with artificial intelligence. Using probabilistic and deep learning algorithms, these AI entities exhibit human-like behaviors, gestures, speeches and emotional quotients tailored to specific legal cultures and jurisdictions.

Court room 11 is the courtroom depicted in the application. It includes Virtual Judges & Jurors, mimicking their real-world counterparts, who evaluate evidence, hear arguments, and make determinations based on the data presented and internal algorithms.

First lawyer 12 and second lawyer 13 are engaged in a virtual court proceeding. These AI constructs are designed to interpret legal nuances and provide advice, similar to human lawyers. They can be tailored according to user preferences: expertise, demeanor, or even appearance.

The AI legal system comprises a robust architecture integrating augmented reality, virtual reality, predictive analytics, natural language processing, machine learning and other artificial intelligence techniques to deliver versatile, multi-jurisdictional legal services spanning real world and virtual ecosystems.

At the core is an immersive environment powered by augmented reality (AR) and virtual reality (VR) capabilities that allow users to experience simulated or actual legal proceedings, negotiations, consultations in interactive virtual settings. The AR/VR environment recreations leverage advanced graphics, physics engines, spatial audio and haptics for enhanced realism and engagement.

A user can start a legal scenario, be it a mock trial, a negotiation setting, or legal research. Through voice or gesture, they can set parameters like the type of case, involved parties, or jurisdiction.

Once a scenario is set, users can engage with AI attorneys for advice or consultation. In trial settings, AI judges and jurors come into play, evaluating the presented evidence and arguments.

During consultations or trials, the Predictive Module can be invoked to gauge potential outcomes based on available data, helping users strategize better.

Post-session, users can provide feedback. This not only refines AI personas'responses in the future but also continuously trains the predictive module.

Utilizing AR and VR, the interface is crafted to be deeply engaging. It enables users to navigate diverse legal scenarios with unprecedented realism, from virtual courtrooms to virtual law firms.

A predictive feature can be provided rooted in deep learning, which analyzes past and present case data, legal texts, and user queries to predict possible legal outcomes or recommend strategies.

Multi-modal Input Recognition is a feature of some embodiment. From voice commands, gestures, to haptic feedback, the system can recognizes and respond to varied user inputs.

The user interface is designed to be intuitive and responsive, allowing users to engage naturally with the system through gestures, eye movements, voice commands as facilitated by the Apple Vision Pro AR headset, or physical interactions in real-world scenarios.

Inter-jurisdictional Compatibility and analysis is a feature of some embodiments. Recognizing the diversity in global legal landscapes, the system is adaptable to multiple jurisdictions and can navigate between them seamlessly.

Metaversal Integration is a feature of some embodiments. Designed for the future, it aligns seamlessly with various metaverse environments, ensuring legal processes within such spaces are as robust and nuanced as those in the real world.

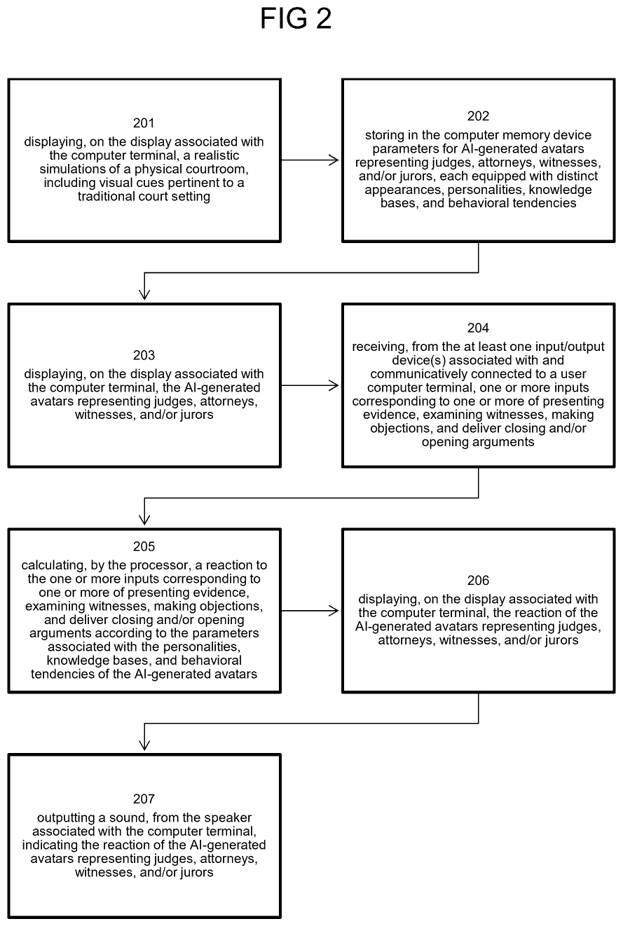

FIG. 2 illustrates an algorithm according to an embodiment for providing a virtual courtroom environment.

Step 201 is displaying, on the display associated with the computer terminal, a realistic simulations of a physical courtroom, including visual cues pertinent to a traditional court setting.

Step 202 is storing in the computer memory device parameters for AI-generated avatars representing judges, attorneys, witnesses, and/or jurors, each equipped with distinct appearances, personalities, knowledge bases, and behavioral tendencies.

Step 203 is displaying, on the display associated with the computer terminal, the AI-generated avatars representing judges, attorneys, witnesses, and/or jurors.

Step 204 is receiving, from the at least one input/output device(s) associated with and communicatively connected to a user computer terminal, one or more inputs corresponding to one or more of presenting evidence, examining witnesses, making objections, and deliver closing and/or opening arguments.

Step 205 is calculating, by the processor, a reaction to the one or more inputs corresponding to one or more of presenting evidence, examining witnesses, making objections, and deliver closing and/or opening arguments according to the parameters associated with the personalities, knowledge bases, and behavioral tendencies of the AI-generated avatars stored in the computer memory.

Step 206 is displaying, on the display associated with the computer terminal, the reaction of the AI-generated avatars representing judges, attorneys, witnesses, and/or jurors.

Step 207 is outputting a sound, from the speaker associated with the computer terminal, indicating the reaction of the AI-generated avatars representing judges, attorneys, witnesses, and/or jurors.

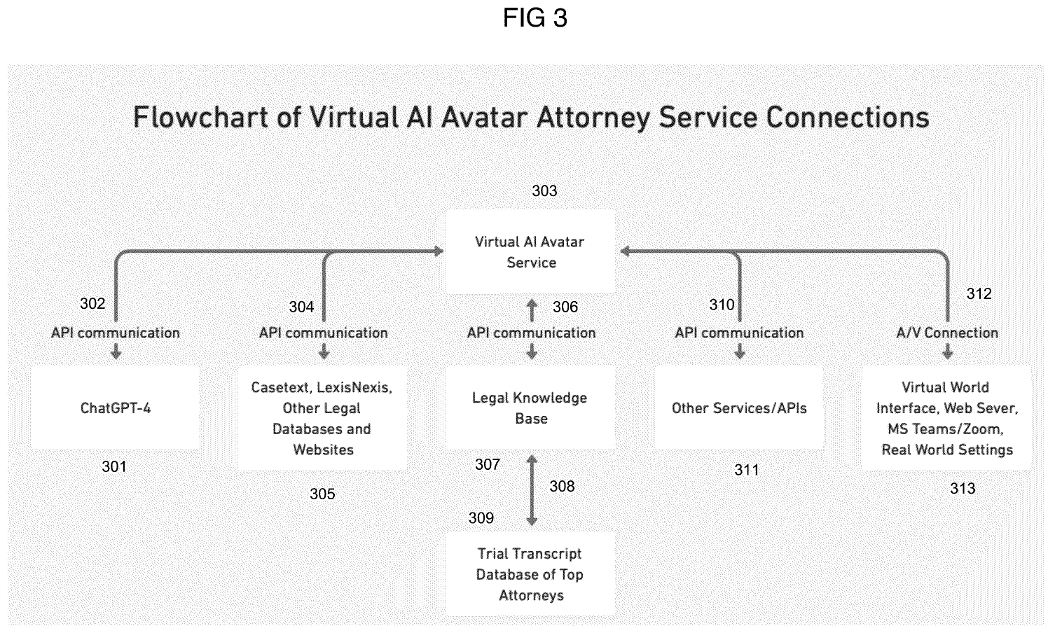

FIG. 3 is a diagram of a technological environment according to an aspect of the present invention.

Virtual AV Avatar Service 303 connects with Chat GPT-4 301 via API communication 302. ChatGPT-4 API key can be provided by Virtual AV Avatar Service 303. Virtual AV Avatar Service 303 can receive humanlike images, text or videos that are created by Chat GPT-4. In other embodiments a different AI chatbot may be utilized.

Virtual AV Avatar Service 303 connects with Legal Databases 305 via API communication 304. Legal databases can include, for example, Case Text, LexisNexis, Westlaw, and the like. A RESTful API may be used to communicate with legal websites. An API key may be provided by Virtual AV Avatar Service 303.

Virtual AV Avatar Service 303 connects with Legal Knowledge Base 307 via API communication 306. Legal Knowledge Base 307 can include practicing attorneys. A RESTful API may be used to communicate. An API key may be provided by Virtual AV Avatar Service 303. Legal Knowledge Base 307 connects to Trial Transcript Database of Top Attorneys 309 via MySQL query 308. A similar database query may be used in place of a MYSQL query.

Virtual AV Avatar Service 303 connects with Other Services/APIs 310 via API communication 310. Other Services/APIs could be a wide range of different applications including applications containing photographs such as Instagram, applications containing geographic and special data such as Google Maps, and a variety of other applications, websites, services, and the like.

A variety of API methods can be used. An API method embodies a method request and a method response. Method request parameters, or an applicable payload, can be set for Virtual AV Avatar Service 303 to provide the required or optional data at run time. For output, the method response status code, headers, and applicable body can be determined as targets to map the backend response data into, before they are returned to Virtual AV Avatar Service 303.

An API method request can be an HTTP request. To set up the method request, an HTTP method (or verb), the path to an API resource, headers, applicable query string parameters are set. A payload can be configured when the HTTP method is POST, PUT, or PATCH. For a non-proxy integration, method responses can specify the required or optional targets of mappings. These transform integration response headers or body to associated method response headers or body. The mapping can be as simple as an identity transform that passes the headers or body through the integration as-is. Often Virtual AV Avatar Service 303 may not know in advance all the responses that a backend may return, and Virtual AV Avatar Service 303 can designate one method response as the default to handle the unknown or unmapped responses from the backend.

Virtual AV Avatar Service 303 connects with Virtual World Interface 313 via A/V connection 312. Virtual World Interface 313 can be video platforms such as Zoom or MS Teams, a web server, or a television or computer monitor, for example. A/V connection 312 can be a wired or wireless connection such as local area network, Wi-Fi connection, axial cable, or a variety of other wireless and wired connections.

A predictive analytics module applies deep learning on case data to anticipate legal outcomes. Modular components allow configuring tailored legal services. Explainable AI features provide transparency into decisions and recommendations made by the system.

The AI engine employs a predictive analytics module that applies machine learning techniques on vast repositories of legal rulings, case laws and data points to uncover patterns, trends and precedents. This enables the system to forecast likely outcomes of new cases and provide users data-driven advice on optimal legal strategies and next steps.

The system architecture ensures flexibility and configurability of components. For instance, different AI modules like the predictive analytics engine, drafting tools, virtual courtroom and negotiating agents can be combined in various ways as standalone applications tailored to specific legal domains and scenarios.

A multi-jurisdictional legal knowledge base coded using ontology-based reasoning underpins the system's capabilities. This allows processing, analyzing and applying legal corpus spanning national and international law, statutes, acts and policies. Real-time translation services enable seamless operation across different languages.

The system employs explainable AI techniques that can describe the rationale and logic behind actions, recommendations or conclusions reached by the AI models to users. This provides transparency and traces decision-making processes, engendering trust.

Interfaces allow integration with physical court technologies including case management systems, evidence presentation tools and digital court records. This enables the AI system to complement real world legal proceedings with virtual counterparts and extensions.

For metaverse environments, adaptive protocols allow the system to conform to the unique rules, cultural nuances and legal conventions specific to individual virtual worlds and user groups. The system can simulate legal processes and agreements spanning real and virtual domains.

A continuous learning framework leverages user feedback, changing regulations and new case laws to consistently train the AI models. This allows the system to stay updated on contemporary legal developments across multiple jurisdictions.

The modular design ensures easy adaptability to emerging legal challenges or evolving metaverse norms. Automating multiple legal tasks can lead to significant savings in time and monetary resources. With multi-jurisdictional capabilities, it caters to a global user base, making legal expertise accessible to many.

The AR and VR system can be adapted to seamlessly switch between augmented and full virtual reality, providing a realistic and adaptable courtroom experience both virtually and in real-world applications.

Embodiments can include a holographic projection capability, enabling users to engage in legal proceedings or consultations in a three-dimensional interactive space.

Embodiments can include real-time shadow counsel, an AI entity operating in the background to provide instant legal advice, recommendations, or alternative strategies during live legal interactions.

The shadow counsel learns and adapts based on the user's legal preferences, strategies, and historical decision-making patterns; and offers counterarguments or plays the devil's advocate, ensuring comprehensive consideration of all legal aspects.

All of the above embodiments can be performed on a computer system having a memory(s), a processor(s), a display device(s), and an input/output device(s). Additionally, computer readable media storing computer readable code for carrying out the method steps identified above is provided. The computer readable media stores code for carrying out subprocesses for carrying out the methods described above.

A computer program product recorded on a computer readable medium for carrying out the method steps identified above is provided. The computer program product comprises computer readable means for carrying out the methods described above.

Having thus described a few particular embodiments of the invention, various alterations, modifications, and improvements will readily occur to those skilled in the art. Such alterations, modifications, and improvements are intended to be part of this description though not expressly stated herein, and are intended to be within the spirit and scope of the invention. Accordingly, the foregoing description is by way of example only, and not limiting.

What is claimed is:

1. A method of creating virtual legal avatars, comprising:
sending a query and an API key to an AI-enabled chat application;
receiving images, text or videos from the AI-enabled chat application;
establishing communication with a legal database via a RESTful API;
receiving images, text or videos from the legal database over the RESTful API;
combining the images, text or videos received from the AI-enabled chat application and data received from the legal database to calculate and store in a computer memory device images and text associated with distinct appearances, personalities, knowledge bases, and behavioral tendencies for AI-generated avatars representing one or more of judges, attorneys, witnesses, and jurors; and
displaying, on the display associated with a user computer terminal, the AI-generated avatars representing judges, attorneys, witnesses, and/or jurors.

2. The method of claim 1, wherein a virtual legal avatar creator mimics real-world user emotions and reactions in real-time using advanced facial recognition and emotion detection algorithms.

3. The method of claim 1, wherein a virtual legal avatar creator mimics provides virtual training scenarios for users to familiarize themselves with their avatars before official proceedings.

4. The method of claim 1, wherein a virtual legal avatar creator creates avatars based on characteristics of real-world judges, attorneys, witnesses, jurors and/or other persons allowing users to craft realistic digital representations of themselves for virtual court appearances.

5. A system for providing a virtual courtroom, comprising:
a computer terminal;
at least one input/output device(s) associated with and communicatively connected to the computer terminal;
a speaker associated with and communicatively connected to the computer terminal;
a computer memory device;
at least one display associated with the computer terminal; and
at least one processor arranged for:
displaying, on the display associated with the computer terminal, a realistic simulations of a physical courtroom, including visual cues pertinent to a traditional court setting;
displaying, on the display associated with the computer terminal, the AI-generated avatars representing judges, attorneys, witnesses, and/or jurors crated by the method of claim 1;
receiving, from the at least one input/output device(s) associated with and communicatively connected to a user computer terminal, one or more inputs corresponding to one or more of presenting evidence, examining witnesses, making objections, and deliver closing and/or opening arguments;
calculating, by the processor, a reaction to the one or more inputs corresponding to one or more of presenting evidence, examining witnesses, making objections, and deliver closing and/or opening arguments according to parameters associated with the personalities, knowledge bases, and behavioral tendencies of the AI-generated avatars stored in the computer memory;
displaying, on the display associated with the computer terminal, the reaction of the AI-generated avatars representing judges, attorneys, witnesses, and/or jurors; and
outputting a sound, from the speaker associated with the computer terminal, indicating the reaction of the AI-generated avatars representing judges, attorneys, witnesses, and/or jurors.

6. The system of claim 5, wherein one or more of the at least one at least one input/output device(s) associated with and communicatively connected to a user computer terminal is a microphone.

7. The system of claim 5, wherein one or more of the at least one at least one input/output device(s) associated with and communicatively connected to a user computer terminal is a camera.

8. The system of claim 5, wherein the one or more inputs corresponding to one or more of presenting evidence, examining witnesses, making objections, and deliver closing and/or opening arguments are received from a user voice transmission.

9. The system of claim 8, wherein the one or more inputs corresponding to one or more of presenting evidence, examining witnesses, making objections, and deliver closing and/or opening arguments are received from user gestures.

10. The system of claim 5, wherein calculating, by the processor, a reaction to the one or more inputs comprises accessing a legal database and assessing a response based on content of the legal database.

11. The system of claim 5, further comprising additional speakers constituting a spatial audio system to replicate acoustics and auditory experiences of the virtual courtroom in a physical space.

12. The system of claim 5, wherein the reaction of the AI-generated avatars representing judges, attorneys, witnesses, and/or jurors comprises emotions and sentiments.

13. The system of claim 5, wherein the reaction of the AI-generated avatars representing judges, attorneys, witnesses, and/or jurors comprises a ruling or verdict.

14. The system of claim 5, wherein a virtual courtroom offers customizable ambient settings, allowing the user to adjust lighting, acoustics, and other environmental parameters for optimal comfort and focus.

15. The system of claim 5, wherein AI-generated jurors can be configured to represent a variety of demographics according to selection parameters relating to a demographic mix.

16. The system of claim 5, wherein the reactions of the AI-generated avatars representing judges, attorneys, witnesses, and/or jurors provide detailed feedback on the simulated courtroom proceedings highlighting strengths and areas for improvement.

17. The system of claim 5, wherein the reactions of the AI-generated avatars representing judges, attorneys, witnesses, and/or jurors utilize a voice modulation feature to adjust tone, pitch, and speech rate to make the simulation more realistic and relatable.

18. The system according to claim 5, wherein the reactions of the AI-generated avatars comprise real-time feedback mechanism offers users instant guidance and recommendations during simulation interactions.

19. The system according to claim 5, wherein calculating, by the processor, a reaction to the one or more inputs comprises utilizing deep learning algorithms to detect inconsistencies, potential tampering, or fabrications within presented evidence.

20. The system according to claim 5, further comprising an interface with physical courtroom technologies, comprising one or more of electronic document management systems, digital stenography tools, and courtroom presentation equipment, optionally synchronized with physical courtroom technologies in particular real-world tribunal.
